(19) United States
(12) Patent Application Publication
(10) Pub. No.: US 2024/0289134 A1
(43) Pub. Date: Aug. 29, 2024

(54) CONTROL METHOD AND ELECTRONIC DEVICE

(71) Applicant: Lenovo (Beijing) Limited, Beijing (CN)

(72) Inventors: Tai-Yu CHIU, Beijing (CN); Kuo-Hsing CHOU, Beijing (CN)

(21) Appl. No.: 18/585,225

(22) Filed: Feb. 23, 2024

(30) Foreign Application Priority Data
Feb. 23, 2023 (CN) 202310173664.7

(51) Int. Cl. G06F 9/4401

(52) U.S. Cl. CPC G06F 9/4401

(57) ABSTRACT

A control method is applied to a first device. The first device includes a first processor and a second processor. The method includes responding to a boot command for the first device to boot the first processor and responding to control by the first processor to boot the second processor to execute a plurality of boot tasks corresponding to the first device in parallel. The second processor is configured to execute at least one boot task of the plurality of boot tasks.

### CROSS-REFERENCE TO RELATED APPLICATION

The present disclosure claims priority to Chinese Patent Application No. 202310173664.7, filed on Feb. 23, 2023, the entire content of which is incorporated herein by reference.

### TECHNICAL FIELD

The present disclosure relates to the computer technology field and, more particularly, to a control method and an electronic device.

### BACKGROUND

When a device such as a laptop starts, a bootstrap processor (BSP) is first booted. Tasks during the boot process are executed by the BSP in sequence, which causes a slow boot speed and low boot efficiency of the device.

### SUMMARY

An aspect of the present disclosure provides a control method. The method is applied to a first device. The first device includes a first processor and a second processor. The method includes responding to a boot command for the first device to boot the first processor and responding to control by the first processor to boot the second processor to execute a plurality of boot tasks corresponding to the first device in parallel. A second processor is configured to execute a boot task of the plurality of boot tasks.

An aspect of the present disclosure provides an electronic device, including a first processor, a second processor, and a memory. The first processor responds to a boot command of the electronic device to boot. The second processor responds to control of the first processor to boot. The second processor executes a plurality of boot tasks corresponding to the electronic device in parallel. A second processor is configured to execute a boot task of the plurality of boot tasks.

### BRIEF DESCRIPTION OF THE DRAWINGS

FIG. 1 illustrates a schematic flowchart of a control method according to some embodiments of the present disclosure.

FIG. 2 illustrates a schematic diagram showing an AP executing a boot task according to some embodiments of the present disclosure.

FIG. 3 illustrates a schematic diagram showing a correspondence between an AP and a PCI interface according to some embodiments of the present disclosure.

FIG. 4 illustrates a schematic diagram showing a correspondence between an AP and a network port according to some embodiments of the present disclosure.

FIG. 5 illustrates a schematic diagram showing an AP detecting a PCI member according to some embodiments of the present disclosure.

FIG. 6 illustrates a schematic diagram showing an AP detecting a network device according to some embodiments of the present disclosure.

FIG. 7 illustrates a schematic diagram of a user selection according to some embodiments of the present disclosure.

FIG. 8 illustrates a schematic structural diagram of an electronic device according to some embodiments of the present disclosure.

FIG. 9 illustrates a schematic flowchart of booting a server according to some embodiments of the present disclosure.

### DETAILED DESCRIPTION OF THE EMBODIMENTS

The technical solution of embodiments of the present disclosure is described in detail in connection with the accompanying drawings of embodiments of the present disclosure. Apparently, described embodiments are merely some embodiments of the present disclosure not all embodiments. Based on embodiments of the present disclosure, all other embodiments obtained by those ordinary skill in the art without creative efforts are within the scope of the present disclosure.

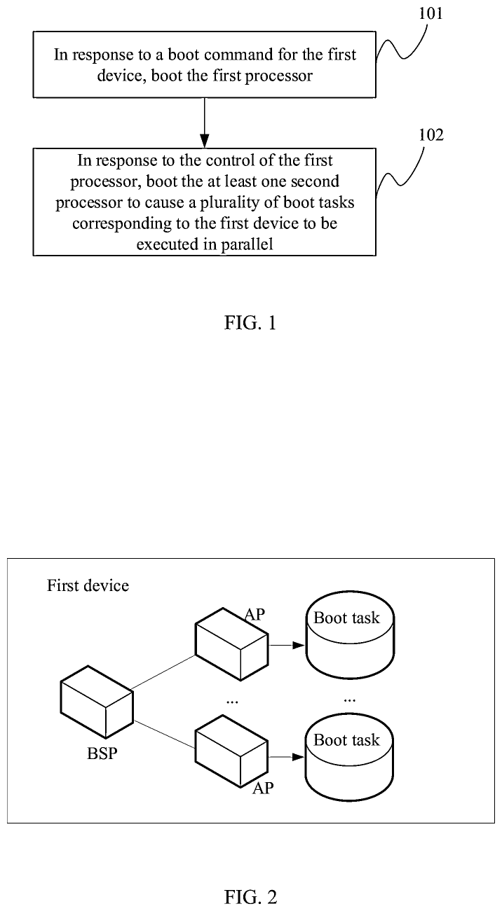

FIG. 1 illustrates a schematic flowchart of a control method according to some embodiments of the present disclosure. The method can be applied to an electronic device, which is used as a first device, such as a computer or a server. The first device can include a first processor and at least one second processor, e.g., a central processing unit (CPU) used as a bootstrap processor (BSP) and at least one CPU core used as an application processor (AP). The technical solution of embodiments of the present disclosure is mainly used to improve the boot efficiency of the electronic device.

In some embodiments, the method of embodiments of the present disclosure includes the following steps.

At 101, in response to a boot command for the first device, the first processor is booted.

The boot command of the first device can be generated when a boot button of the first device is pressed, or when a remote command transmitted by a remote control device is received. Based on this, in response to the boot command, the first processor can be first booted.

The booted first processor can be configured to control other processors, including the second processor.

At 102, in response to the control of the first processor, the at least one second processor is booted to cause a plurality of boot tasks corresponding to the first device to be executed in parallel.

A second processor can be configured to execute at least one boot task.

In some embodiments, booting the first processor can include the first processor calling a target service assembly configured in the first device. The target service assembly can be configured to trigger the at least one second processor to be booted. The booted second processor can be configured to execute at least one boot task. Thus, the plurality of boot tasks corresponding to the first device can be executed in parallel.

For example, taking a server as the first device, the target service assembly can be a MPservice assembly configured in the server. Based on this, after the boot button on the server is pressed by a user, a boot command can be generated in the server. In response to the boot command, one core of the CPU in the server can be booted as the BSP. After the BSP is booted, the BSP can call the MPService assembly. The MPService assembly can trigger a plurality of cores, which are used as application processors (APs), to be booted. As shown in FIG. 2, The plurality of APs can execute the plurality of boot tasks of the server in parallel. Thus, the boot of the server can be accelerated, and the boot efficiency can be improved.

According to the above solution, in the control method of embodiments of the present disclosure, after the first processor is booted in response to the boot command for the electronic device, the at least one second processor of the electronic device can be booted through the control of the first processor. Thus, the plurality of boot tasks corresponding to the electronic device can be executed in parallel. One second processor can be configured to execute at least one boot task of the plurality of boot tasks. Thus, in embodiments of the present disclosure, the first processor that is booted first can control the boot of the at least one second processor. Then, the second processor can be configured to execute the boot tasks of the electronic device in parallel to avoid a low boot speed when the boot tasks are booted in sequence. Thus, the boot efficiency of the electronic device can be improved.

In some embodiments, the second processor can have correspondence with the boot tasks. The correspondence can be used to instruct the first processor to control the second processor to execute the corresponding boot tasks.

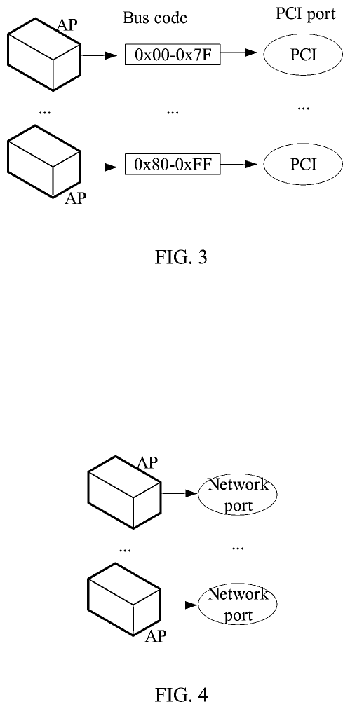

In some embodiments, the correspondence can be pre-configured. For example, bus code of the first device can be divided into segments in advance, such as 0x00-0x7F and 0x80-0xFF. Bus code of each bus code segment can be assigned to the APs to form a correspondence between each AP and the bus code of each segment. The bus code can correspond to a corresponding PCI port. As shown in FIG. 3, a correspondence between each AP and the corresponding PCI port is formed. For example, as shown in FIG. 4, network ports of the first device can be assigned to the APs in advance to form a correspondence between each AP and a corresponding network port.

For example, the boot task can be PCI port detection. The AP and the PCI port can have correspondence in the corresponding bus number. The correspondence can be used to instruct the BSP to control each AP to perform detection on the PCI port of the bus number corresponding to the AP. Based on this, after the BSP is booted, the BSP can control the APs to boot by calling the MPService. The booted APs can perform the detection on the PCI ports of the bus numbers corresponding to the APs according to the configured correspondence.

For example, the boot task can be the network port detection. The AP and the network port can have correspondence. The correspondence relationship can be used to instruct the BSP to control each AP to perform detection on the network port corresponding to the AP. Based on this, after the BSP is booted, the BSP can control the boot of the APs by calling the MPService. The booted APs can perform detection on the network ports corresponding to the APs according to the configured correspondence.

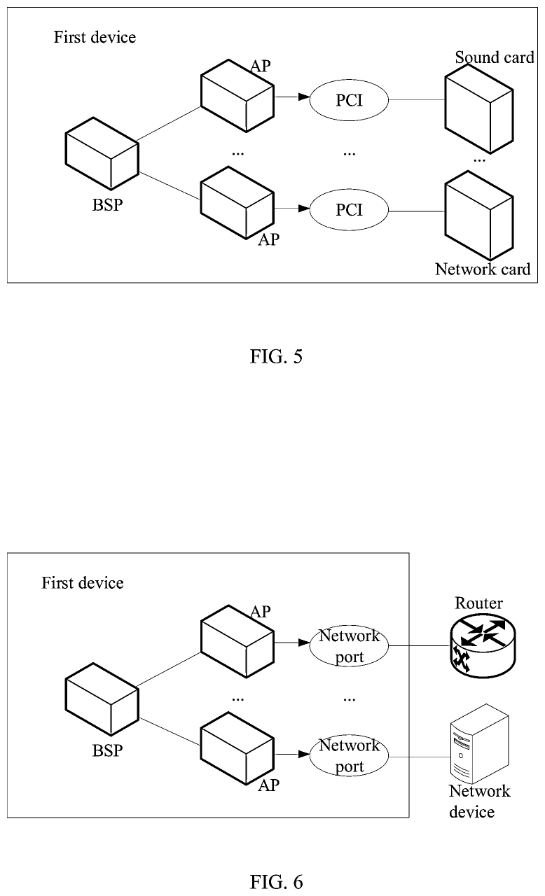

In some embodiments, a boot task can correspond to at least one first component in the first device. The first member can be connected to other members of the first device. For example, the first member can be a PCI port of the first device. As shown in FIG. 5, a PCI port can be connected to other members that are connected via PCI ports in the server, e.g., a sound card, a network card, or a graphics card based on the PCI ports.

Based on this, in some embodiments, the second processor performing the boot task can include the second processor detecting at least one member attribute of the first member and performing initialization on member parameters of the first member.

In some embodiments, the member attribute can include any one or more of a resource attribute, a bus attribute, and an Option ROM attribute. For example, when the first member is the PCI port, the member attribute can include I/O space and memory space of the PCI port, bus protocol, and whether supports OPROM and the size of the OPROM. The member parameter can include any one or more of a resource parameter, a bus parameter, and an Option ROM parameter (i.e., OR parameter).

Based on this, the second member can perform initialization on the member parameter of the first member. In some embodiments, the second processor can perform initialization on the member parameter of the first member according to a resource list of the first device. For example, the first device can be a server. The resource list can be a resource table of the server. The resource table can store information corresponding to a plurality of CPUs such as CPU0 and CPU1. Each CPU can include a plurality of cores such as ins00-ins11. Each core can correspond to information such as a bus code segment and relevant IO resource.

For example, when the first member is a PCI port, the member parameter can include parameters such as a storage resource, IO resource, bus protocol, bus identification, and OPROM size of the PCI port. Based on this, after the BSP of the server is booted, the BSP can control the boot of the APs by calling the MPService. The booted APs can perform port status detection on the corresponding PCI ports of the bus code and perform parameter initialization according to the resource table of the server, e.g., detect the storage resource, the IO resource, the bus identification, whether the OPROM is supported, and the size of the OPROM, update the storage resources, and IO resources of the ports, and configure the bus and the size of the OPROM.

In some embodiments, a boot task can at least correspond to a second member configured in the first device. The second member can cause the first device to be connected to the second device. For example, the second member can include a structure such as a network port. As shown in FIG. 6, the second member is connected to an external device corresponding to the first device, e.g., a router, a switch, or other network devices connected based on network cables.

Based on this, in some embodiments, the second processor executing the boot task can include the second processor detecting whether the second member is connected to the second device to obtain an execution result and transmit the execution result to the first processor.

The execution result can be used to indicate whether the second member is connected to the second device.

In some embodiments, the second processor can collect a member status of the second member. The member status can indicate whether the second member is connected to the second device. For example, the AP can collect a port status of the corresponding network port. The port status can indicate whether the network port is connected to a network cable. The network cable can be connected to a network device. Thus, the port status can indicate whether the network port is connected to the network device.

Based on the above solution, when the execution result indicates that the second member is connected to the second device, in some embodiments, in response to the control of the first processor, the second processor can obtain functional data corresponding to the second device connected to the second member and transmit the functional data to the first processor. The functional data can indicate whether the second device can realize a target function.

For example, the first device can be a server, after the BSP receives the execution result, the BSP can call the MPService again to trigger the corresponding AP to obtain the functional data transmitted by the network device based on the corresponding communication protocol. The communication protocol can include a Transmission Control Protocol Internet Protocol (TCP/IP) V4/V6, an Address Resolution Protocol (ARP), a Manager Network Service Binding Protocol (MNP), a Simple Network Protocol (SNP), etc. The functional data can be the data related to a specific function of the network device, e.g., data related to Pxe/iSCST, which indicates whether the network device realizes the function, e.g., a function of Pxe/iSCSI.

Based on this, after receiving the functional data, the first processor can output a functional selection interface corresponding to the second member according to the functional data. The functional selection interface can include a selection controller corresponding to the second device. When the selection controller is selected, an operation corresponding to each function can be executed at the first device.

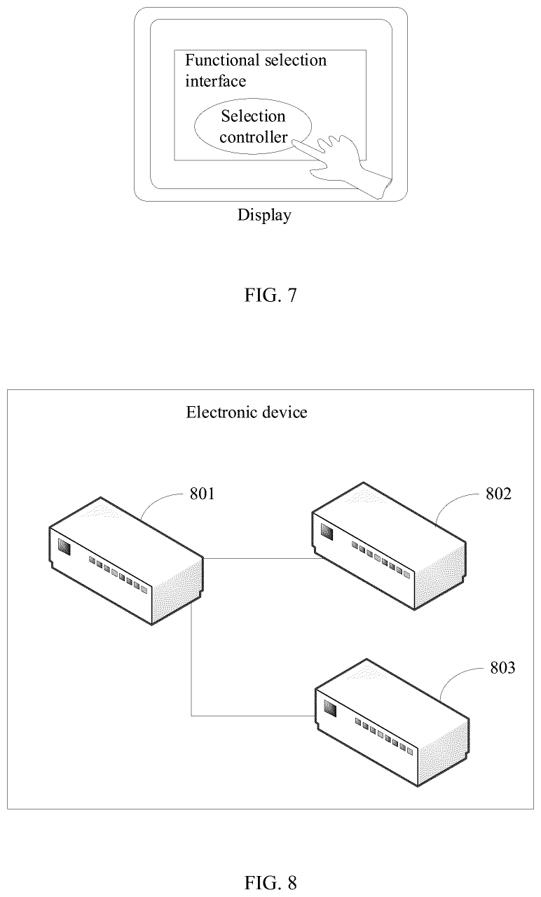

For example, as shown in FIG. 7, the functional selection interface is output on the display connected to the server to display the selection controller corresponding to the network device of the PXE/iSCSI. The user can select the selection controller. Based on this, in response to the selection operation of the user for the selection controller, the server can execute the function of the PXE/iSCSI.

FIG. 8 illustrates a schematic structural diagram of an electronic device according to some embodiments of the present disclosure. The electronic device can be the first device and includes a first processor 801 and at least one second processor 802.

The first processor 801 can be an independent processing chip or one first core of a multi-core processor.

The at least one second processor 802 can be an independent processing chip or at least one second core of the multi-core processor.

For example, the first processor 801 can be one processing core of a CPU including a plurality of processing cores. Correspondingly, the second processor 802 can be another processing core of the CPU.

The first processor 801 can respond to the boot command for the electronic device. The at least one second processor 802 can be booted in response to the control of the first processor 801 to cause the plurality of boot tasks corresponding to the electronic device to be executed in parallel. A second processor 802 can be configured to execute at least one boot task.

In the electronic device of embodiments of the present disclosure, after booting the first processor in response to the boot command for the electronic device, the at least one second processor of the electronic device can be booted through the control of the first processor. Thus, the plurality of boot tasks corresponding to the electronic device can be executed in parallel. A second processor can be configured to execute at least one boot task of the plurality of boot tasks. Thus, in some embodiments, the first processor that is booted first can control the at least one second processor to boot in the electronic device. Then, the boot tasks of the electronic device can be executed in parallel by the second processor, which avoids a slow boot speed caused by executing the boot tasks in sequence, and the boot efficiency of the electronic device can be improved.

For example, for the scene of booting the server in the development environment for BIOS, UEFI, and PI, UEFI boot can be performed by running code through the BSP, and other APs do not run. Because only one piece of code is running, many events that can be performed in parallel cannot be performed with an accelerated speed.

For the above problems, the present disclosure provides the following solution.

With the MPService provided by EDK2, the boot tasks can be processed in parallel to reduce the boot time. EDK2 can be configured to specify a processor to perform a designated task.

For example, a PCI enumeration task after boot can use the resource table provided by Intel or AMD to cause the AP to perform enumeration on different root bridges in parallel, e.g., updating resource/bus number/OPROM, etc.

The PCI host bridge controller driver can be bound to specific platform hardware. According to the actual I/O space and memory map of the system, ranges of the I/O space and memory space can be specified for the PCI member, and a PCI HOST Bridge Resource Allocation protocol can be generated and can be used by the PCI bus driver. The driver can also generate handles for all RootBridge devices under the HostBridge controller. PciRootBridgeProtocol can be installed at the handles. The PCI bus driver can use the PciRootBridgeIO Protocol to enumerate all PCI members in the system, discover and obtain the Option ROM of the PCI members, and call the PCI HOST Bridge Resource Allocation protocol to program the PCI HostBridge Controller.

For another example, network devices can install UNDI drivers and use the SNP protocol to transmit or detect media present. Since the EDK architecture is in a timer event manner without an interrupting service, if 2 seconds is needed to confirm one port, 10 seconds may be needed to confirm 5 ports. In the present disclosure, the plurality of APs can be caused to respond to a timer event to confirm different ports through MpService to reduce the time needed for confirming the ports.

In addition, for port detection of some Network stacks (TCP IPv4/v6, MNP, and User Datagram Protocol (UDP), the plurality of APs can also be configured to detect an underlying service of each port to save time.

After adopting the solution of the present disclosure, the time for the PCI enumeration can be reduced, and some information related to OPROM can be determined in advance to allow the BSP to know which OPROM versions are new to load the newest OPROM. The determination of the Media Present for the Network device or command transmission can be performed in parallel by the plurality of APs to reduce the time consumed.

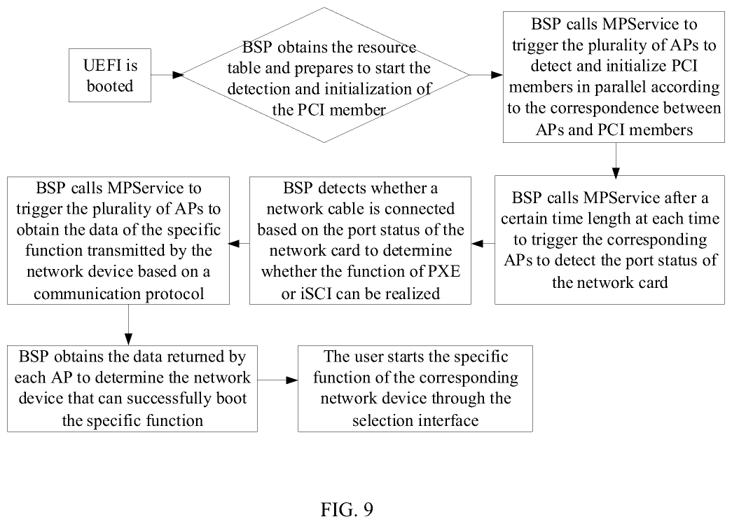

As shown in FIG. 9, the method includes the following processes.
1. During UEFI Boot, UEFI is booted on the operating system, and the BSP starts to run.
2. In the record resource table for PCIe enumeration, i.e., PEI phase, the BSP obtains the resource table and prepares to start the detection and initialization of the PCI member.
3. In Call MPService to do PCIe enumeration (resource/bus number/OPROM), i.e., DXE phase, the BSP calls MPService to trigger the plurality of APs to detect and initialize PCI members in parallel according to the correspondence between APs and PCI members.
4. When SNP creates a timer event that will call MpService to let AP detect media present status, i.e., in a BDS phase, SNP creates a timer for each AP to enable the BSP to actively call MPService after a certain time length at each time to trigger the corresponding APs to detect the port status of the network card. The port status of the network card indicates whether the port of the network card is connected to the network device and whether the connected network device supports a specific function.
5. In BSP bases media present status to do PXE or iSCSI boot on network devices, BSP detects whether a network cable is connected based on the port status of the network card to determine whether the function of PXE or iSCI can be realized.
6. BSP calling MPService to APs to check TCP IPV4/V6, ARP, MNP, SNP timer event to get PXE includes BSP calling MPService to trigger the plurality of APs to obtain the data of the specific function transmitted by the network device based on a communication protocol (e.g., IPv4).
7. BSP checking each APs return data to figure out which network device successfully could boot PXE or iSCSI service includes BSP obtaining the data returned by each AP to determine the network device that can successfully boot the specific function.
8. Do optimize PXE boot order to boot into PXE/iSCSI includes the user starting the specific function of the corresponding network device through the selection interface.

Embodiments of the present disclosure are described in a progressive manner. Each embodiment focuses on the differences from other embodiments. The same or similar parts among different embodiments can be cross-referenced. Since the apparatus of embodiments of the present disclosure corresponds to the method of embodiments of the present disclosure, the apparatus can be simply described. For the relevant parts, reference can be made to the description of the method.

Those skilled in the art can further appreciate that units and algorithm steps of the examples of embodiments of the present disclosure can be realized in electronic hardware, computer software, or a combination thereof. To clearly describe the interchangeability between the hardware and the software, the composition and steps of examples have been described above according to the functions. Whether the functions are executed by hardware or software depends on the specific application and design constraint condition of the technical solution. Those skilled in the art can realize the described functions in different methods for each specific application, which is within the scope of the present disclosure.

The steps of the method or algorithm of embodiments of the present disclosure can be directly implemented by hardware, software module executed by the processor, or a combination thereof. The software module can be stored in a random access memory (RAM), a memory, a read-only memory (ROM), an electrically programmable ROM, an electrically erasable programmable ROM, a register, a hard drive, a removable disk, a CD-ROM, or any other storage medium known in the art.

The above description of embodiments of the present disclosure can enable those skilled in the art to implement or use the present disclosure. Various modifications to these embodiments can be apparent to those skilled in the art. The general principles defined here can be applied to other embodiments without departing from the spirit or scope of the present disclosure. Thus, the present disclosure is not limited to embodiments of the present disclosure but is subject to the widest scope consistent with the principles and novel features of the present disclosure.

What is claimed is:

1. A control method, applied to a first device including a first processor and a second processor, comprising:
responding to a boot command for the first device to boot the first processor; and
responding to control by the first processor to boot the second processor to execute a plurality of boot tasks corresponding to the first device in parallel, the second processor being configured to execute at least one boot task of the plurality of boot tasks.

2. The method according to claim 1, wherein a correspondence exists between the second processor and the boot task, and the correspondence is used to instruct the first processor to control the second processor to execute the corresponding boot task.

3. The method according to claim 1, wherein:
a boot task corresponds to a first member of the first device;
the first member is able to connect to another member of the first device; and
the second processor executing the boot task includes the second processor detecting at least one member attribute of the first member and performing initialization on a member parameter of the first member.

4. The method according to claim 3, wherein:
the member attribute includes any one or more of a resource attribute, a bus attribute, and an Option ROM attribute; and
the member parameter includes one or more of a resource parameter, a but parameter, and an Option ROM parameter.

5. The method according to claim 3, wherein the second processor performing the initialization on the member parameter of the first device includes:
the second processor performing initialization on the member parameter of the first device according to the resource table of the first device.

6. The method according to claim 1, wherein:
the boot task corresponds to a second member configured in the first device;
the second member enables the first device to be connected to a second device;
the second processor executing the boot task includes the second processor detecting whether the second member is connected to the second device to obtain and send an execution result to the first processor.

7. The method according to claim 6, wherein the second processor detecting whether the second member is connected to the second device includes:
the second processor collecting a member status of the second member, the member status indicating whether the second member is connected to the second device.

8. The method according to claim 6, further comprising, when the execution result indicates that the second member is connected to the second device:
in response to the control of the first processor, the second processor obtaining and transmitting functional data corresponding to the second device connected to the second member to the first processor, the functional data indicating whether the second device is able to realize a target function.

9. The method according to claim 1, wherein booting the first processor includes:
the first processor calling a target service assembly configured in the first device, the target service assembly being configured to trigger the second processor to boot.

10. An electronic device comprising:
a first processor;
a second processor; and
a memory;
wherein:
the first processor responds to a boot command of the electronic device to boot;
the second processor responds to control of the first processor to boot, the second processor executing a plurality of boot tasks corresponding to the electronic device in parallel; and
a second processor is configured to execute at least one boot task of the plurality of boot tasks.

11. The device according to claim 10, wherein a correspondence exists between the second processor and the boot task, and the correspondence is used to instruct the first processor to control the second processor to execute the corresponding boot task.

12. The device according to claim 10, wherein:
a boot task corresponds to a first member of a first device;
the first member is able to connect to another member of the first device; and
the second processor is further configured to detect at least one member attribute of the first member and perform initialization on a member parameter of the first member.

13. The device according to claim 12, wherein:
the member attribute includes any one or more of a resource attribute, a bus attribute, and an Option ROM attribute; and
the member parameter includes one or more of a resource parameter, a but parameter, and an Option ROM parameter.

14. The device according to claim 12, wherein the second processor is further configured to perform initialization on a member parameter of the first device according to a resource table of the first device.

15. The device according to claim 10, wherein:
the boot task corresponds to a second member configured in the first device;
the second member enables the first device to be connected to a second device;
the second processor executing the boot task includes the second processor detecting whether the second member is connected to the second device to obtain and send an execution result to the first processor.

16. The device according to claim 15, wherein the second processor is further configured to:
collect a member status of the second member, the member status indicating whether the second member is connected to the second device.

17. The device according to claim 15, wherein when the execution result indicates that the second member is connected to the second device, the second processor is further configured to:
in response to the control of the first processor, obtain and transmit functional data corresponding to the second device connected to the second member to the first processor, the functional data indicating whether the second device is able to realize a target function.

18. The device according to claim 10, wherein the first processor is further configured to:
call a target service assembly configured in the first device, the target service assembly being configured to trigger the second processor to boot.
